(19) United States
(12) Patent Application Publication
(10) Pub. No.: US 2025/0066566 A1
(43) Pub. Date: Feb. 27, 2025

(54) HEAT-SHRINKABLE POLYESTER FILM

(71) Applicants: C.I. TAKIRON Corporation, Osaka (JP); Bonset America Corporation, Browns Summit, NC (US)

(72) Inventors: Takuma KANEKO, Osaka (JP); Yuichiro KANZAKA, Osaka (JP); Shuuta YUGE, Osaka (JP); Tatsuya IRIFUNE, Osaka (JP)

(21) Appl. No.: 18/725,929

(22) PCT Filed: Sep. 28, 2022
(86) PCT No.: PCT/JP2022/036182

§ 371 Date: Jul. 1, 2024

(30) Foreign Application Priority Data
Mar. 31, 2022 (JP) 2022-059418

(51) Int. Cl. C08J 5/18; B29C 48/00; B29C 48/08; B29C 55/14; B29K 67/00

(52) U.S. Cl. CPC C08J 5/18; B29C 48/022; B29C 48/08; B29C 55/14; B29C 2948/92704; B29K 2067/003; B29K 2995/0049; C08J 2367/02

(57) ABSTRACT

A heat-shrinkable polyester film that effectively suppresses a breakage phenomenon after thermal shrinkage is provided.

The heat-shrinkable polyester film is a heat-shrinkable polyester film derived from a polyester resin composition including a crystalline polyester resin in an amount of 10% to 70% in which a main shrinkage direction is designated as TD direction, a direction orthogonally intersecting the TD direction is designated as MD direction, and the heat-shrinkable polyester film satisfies the following configurations (a) and (b):
(a) when an upper yield point stress in a stress-strain curve in the MD direction is designated as E1 (MPa), and a lower yield point stress is designated as E2 (MPa), the value of E1−E2 satisfies the following relational expression (1):

$$23.5 \leq E 1 - E 2 \leq 50 ; \qquad ( 1 )$$

(b) a thermal shrinkage ratio A1 (TD direction at 98° C. for 10 seconds) is 30% or more.

### TECHNICAL FIELD

The present invention relates to a heat-shrinkable polyester film (hereinafter, sometimes called as a polyester-based shrink film, or simply as a shrink film).

More particularly, the present invention relates to a heat-shrinkable polyester film that has satisfactory thermal shrinkage ratios and at the same time, after being produced as a shrink label and wrapped around a bottle by shrinking, provides excellent breakage prevention property (hereinafter, may be simply referred to as breakage prevention property) which prevents the label from being damaged during transportation and storage.

### BACKGROUND ART

Conventionally, shrink films have been widely used as base films for labels of PET bottles and the like. Particularly, it is the current situation that heat-shrinkable polyester films are increasing their market share as base films for labels due to their excellent mechanical strength, transparency, and the like.

Although such a heat-shrinkable polyester film has excellent mechanical characteristics, there is observed a problem that when the heat-shrinkable polyester film is heated and shrunk, tension, impact, and the like occur due to rapid thermal response, and the film itself is likely to break.

In addition, a heat-shrinkable film is affected by the storage conditions for shrink films, particularly humidity and the like, so that physical properties such as the thermal shrinkage ratio at a predetermined temperature vary, and furthermore, there is observed a problem that breakage prevention property during transportation and storage is likely to be decreased.

Thus, in order to improve breakage prevention property and the like of labels, various heat-shrinkable polyester films suitable for use in labels, which have high thermal shrinkage ratios in the width direction while having low thermal shrinkage ratios in the longitudinal direction, have high mechanical strength in the longitudinal direction, and have satisfactory perforation opening property and excellent shrink finish property, have been proposed (see, for example, Patent Document 1).

More specifically, a biaxially stretched heat-shrinkable polyester film satisfying the following configuration requirements (1) to (6) is available.
(1) 1,4-cyclohexanedimethanol is used as an amorphous monomer in an amount in a range of 5 mol % or more and 30 mol % or less in 100 mol % of the alcohol component.
(2) The hot water thermal shrinkage ratio obtained when the film is immersed in hot water at 98° C. for 10 seconds is 60% or more and 90% or less in the main shrinkage direction of the film.
(3) The hot water thermal shrinkage ratio obtained when the film is immersed in hot water at 98° C. for 10 seconds is-5% or more and 5% or less in a direction orthogonally intersecting the main shrinkage direction of the film.
(4) The right-angle tear strength per unit thickness in the direction orthogonally intersecting the main shrinkage direction after shrinking the film by 10% in the main shrinkage direction in hot water at 80° C. is 180 N/mm or more and 350 N/mm or less.
(5) The maximum shrinkage stress in the main shrinkage direction of the film measured with hot air at 90° C. is 2 MPa or more and 10 MPa or less, and the shrinkage stress after 30 seconds from the start of measurement is 60% or more and 100% or less of the maximum shrinkage stress.
(6) The difference between the hot water thermal shrinkage ratios in the main shrinkage direction at 70° C. measured before and after an aging treatment at a temperature of 30° C., a humidity of 65% RH for 672 hours, is 10% or less.

### CITATION LIST

### Patent Document

Patent Document 1: JP 2019-81378 A (claims and the like)

### DISCLOSURE OF THE INVENTION

### Problem to be Solved by the Invention

However, in the case of the heat-shrinkable polyester film disclosed in Patent Document 1, no consideration has been given to an attempt at blending a predetermined amount of a crystalline polyester resin to produce a heat-shrinkable polyester film and controlling the hygroscopic property and the like in order to reduce variation in the physical properties such as thermal shrinkage ratio.

Furthermore, in the case of such a heat-shrinkable polyester film, an aging treatment is performed under the conditions of 30° C. or lower and 65% RH for 672 hours, and the difference between the hot water thermal shrinkage ratios in the main shrinkage direction at 70° C. measured before and after the aging treatment is controlled to a value of 10% or less; however, since hygroscopic property is not taken into consideration, in reality, stable control of the thermal shrinkage ratio is difficult.

In addition, when such a heat-shrinkable polyester film is used as a label, in order to prevent damage caused by impact such as dropping during transportation, the right-angle tear strength in the longitudinal direction (MD direction) under predetermined conditions is specified to have a value within a predetermined numerical value range; however, this is still insufficient.

Therefore, the heat-shrinkable polyester film disclosed in Patent Document 1 frequently has a problem that after the heat-shrinkable polyester film is produced into a shrink label and is shrunk to be wrapped around a PET bottle, the label is damaged during transportation and storage.

Thus, the inventors of the present invention made extensive efforts in view of the above-described problems, and as a result, the inventors solved the problems in the related art by providing a heat-shrinkable polyester film derived from a polyester resin composition including a predetermined amount of a crystalline polyester resin, which has at least predetermined configurations (a) and (b).

That is, it is an object of the present invention to provide a heat-shrinkable polyester film that has satisfactory thermal shrinkage ratios and excellent breakage prevention property.

### Means for Solving Problem

According to the present invention, there is provided a heat-shrinkable polyester film derived from a polyester resin composition including a crystalline polyester resin in an amount in a range of 10% to 70% by weight with respect to a total resin amount, in which a main shrinkage direction is designated as TD direction, a direction orthogonally intersecting the TD direction is designated as MD direction, and the heat-shrinkable polyester film satisfies the following configurations (a) and (b), and the above-mentioned problems can be solved.

(a) When an upper yield point stress in a stress-strain curve in the MD direction is designated as E1 (MPa), and a lower yield point stress is designated as E2 (MPa), the value of E1−E2 satisfies the following relational expression (1):

$$23.5 \leq E 1 - E 2 \leq 50 \qquad ( 1 )$$

(b) When a thermal shrinkage ratio in a case where the heat-shrinkable polyester film is shrunk in the TD direction under the conditions of 10 seconds in hot water at 98° C. is designated as A1, the A1 has a value of 30% or more.

That is, as the heat-shrinkable polyester film of the present invention includes a predetermined amount of a crystalline polyester resin and satisfies all of configurations (a) and (b), excellent breakage prevention property in which after the heat-shrinkable polyester film is produced into a shrink label and is shrunk to be wrapped around a bottle, the label is not damaged during transportation and storage, can be obtained while maintaining satisfactory thermal shrinkability.

The breakage prevention property can be determined, for example, according to the evaluation criteria in Evaluation 7 in Example 1.

Upon configuring the present invention, as configuration (c), it is preferable that a value of E1, which is the upper yield point stress, is made larger than a value of E2, which is the lower yield point stress, and E1 has a value within a range of 40 to 70 MPa, while E2 has a value within a range of 15 to 45 MPa.

By specifically limiting each of E1 and E2 to a value within a predetermined range in the relationship between E1 and E2 in this way, a numerical value represented by E1-E2 is more easily controlled, and more satisfactory breakage prevention property of the film can be obtained while maintaining satisfactory thermal shrinkability.

Upon configuring the present invention, as configuration (d), when a thermal shrinkage ratio in a case where the heat-shrinkable polyester film is shrunk in the TD direction under the conditions of 10 seconds in hot water at 80° C. is designated as A2, it is preferable that the A2 has a value of 51% or less.

By limiting the thermal shrinkage ratio represented by A2 to be equal to or less than a predetermined value in this way, the breakage prevention property of the film can be further improved by reducing influencing factors on the numerical value represented by E1−E2.

Upon configuring the present invention, as configuration (e), when a thermal shrinkage ratio in a case where the heat-shrinkable polyester film is shrunk in the TD direction under the conditions of 10 seconds in hot water at 70° C. is designated as A3, it is preferable that the A3 has a value of 20% or less.

By specifically limiting the thermal shrinkage ratio represented by A3 to be equal to or less than a predetermined in this way, the breakage prevention property of the film can be further improved by reducing influencing factors on the numerical value represented by E1−E2.

Upon configuring the present invention, as configuration (f), when the tensile modulus of elasticity in the MD direction as measured according to JIS K 7127:1999 is designated as C, it is preferable that the C has a value within a range of 1400 to 1800 MPa.

By specifically limiting the tensile modulus of elasticity represented by C to a value within a predetermined range in this way, the numerical value represented by E1−E2 can be controlled more easily, and more satisfactory breakage prevention property of the film can be obtained while maintaining satisfactory thermal shrinkability.

Upon configuring the present invention, as configuration (g), it is preferable that b* in the chromaticity coordinates in the CIE 1976 L*a*b* (hereinafter, may be simply referred to as CIE chromaticity coordinates) as measured according to JIS Z 8781-4:2013 has a value within a range of 0.15 to 0.5.

By limiting b* in the CIE chromaticity coordinates to a value within a predetermined range in this way, the heat-shrinkable polyester film has excellent transparency, and the blending amount of the crystalline polyester resin and the like can be controlled more accurately to a desired range, though indirectly.

Upon configuring the present invention, as configuration (h), it is preferable that the thickness of the film before thermal shrinkage has a value within a range of 10 to 100 μm.

By specifically limiting the thickness of the heat-shrinkable polyester film before thermal shrinkage to a value within a predetermined range in this way, each of the upper yield point stress E1, the lower yield point stress E2, the numerical value represented by E1−E2, the tensile modulus of elasticity C, and the like can be controlled more easily to a value within a predetermined range.

Upon configuring the present invention, as configuration (i), it is preferable that the haze value of the film before thermal shrinkage as measured according to JIS K 7136:2000 has a value of 8% or less.

By specifically limiting the haze value to be equal to or less than a predetermined value in this way, the transparency of the heat-shrinkable polyester film is more easily controlled quantitatively, and since the transparency is satisfactory, versatility can be further enhanced.

### BRIEF DESCRIPTION OF DRAWINGS

FIGS. 1A to 1C are each a diagram for describing a form of a heat-shrinkable polyester film;

FIG. 2 is a diagram for describing the relationship between the blending amount of a crystalline polyester resin in the heat-shrinkable polyester film and the value of b* in the CIE chromaticity coordinates;

FIG. 3 is a diagram for describing the relationship between the blending amount of the crystalline polyester resin in the heat-shrinkable polyester film and the value of E1−E2, which is the difference between an upper yield point stress E1 and a lower yield point stress E2 in an SS curve in the MD direction;

FIG. 4 is a diagram for describing the relationship between the blending amount of the crystalline polyester resin in the heat-shrinkable polyester film and the breakage prevention property (relative value);

FIG. 5 is a typical example of an SS curve in the MD direction of the heat-shrinkable polyester film and is a diagram for describing the upper yield point stress E1 and the lower yield point stress E2 in the SS curve in the MD direction, and the tensile modulus of elasticity in the MD direction;

FIG. 6 is a diagram for describing the relationship between the value of E1−E2, which is the difference between the upper yield point stress E1 and the lower yield point stress E2 in the SS curve in the MD direction, and the breakage prevention property (relative value);

FIG. 7 is a diagram for describing the relationship between a thermal shrinkage ratio A1 in the TD direction of the heat-shrinkage polyester film under predetermined heating conditions (hot water at 98° C. for 10 seconds) and the value of E1−E2, which is the difference between the upper yield point stress E1 and the lower yield point stress E2 in the SS curve in the MD direction;

FIG. 8 is a diagram for describing the relationship between a thermal shrinkage ratio A2 in the TD direction of the heat-shrinkable polyester film under predetermined heating conditions (hot water at 80° C. for 10 seconds) and the value of E1−E2, which is the difference between the upper yield point stress E1 and the lower yield point stress E2 in the SS curve in the MD direction;

FIG. 9 is a diagram for describing the relationship between a thermal shrinkage ratio A3 in the TD direction of the heat-shrinkable polyester film under predetermined heating conditions (hot water at 70° C. for 10 seconds) and the value of E1−E2, which is the difference between the upper yield point stress E1 and the lower yield point stress E2 in the SS curve in the MD direction; and

FIG. 10 is a diagram for describing the relationship between a tensile modulus of elasticity C in the MD direction and the value of E1−E2, which is the difference between the upper yield point stress E1 and the lower yield point stress E2.

### BEST MODES FOR CARRYING OUT THE INVENTION

### First Embodiment

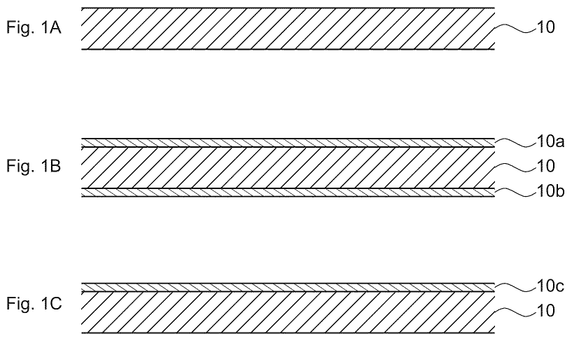

A first embodiment is, as illustrated in FIGS. 1A to 1C, a heat-shrinkable polyester film 10 derived from a polyester resin composition including a crystalline polyester resin in an amount in a range of 10% to 70% by weight with respect to the total resin amount, in which a main shrinkage direction is designated as TD direction, and a direction orthogonally intersecting the TD direction is designated as MD direction, and the heat-shrinkable polyester film satisfies the following configurations (a) and (b):
(a) when an upper yield point stress in a stress-strain curve in the MD direction is designated as E1 (MPa), and a lower yield point stress is designated as E2 (MPa), the value of E1−E2 satisfies the following relational expression (1):

$$23.5 \leq E 1 - E 2 \leq 50 ; \qquad ( 1 )$$

(b) when a thermal shrinkage ratio in a case where the heat-shrinkable polyester film is shrunk in the TD direction under the conditions of 10 seconds in hot water at 98° C. is designated as A1, the A1 has a value of 30% or more.

Hereinafter, the heat-shrinkable polyester film of the first embodiment will be specifically described by dividing the configurations, with appropriate reference to the drawings.

### 1. Polyester Resin

Regarding a polyester resin, which is a main component, the type thereof is basically not limited as long as it is a polyester resin that is likely to satisfy the above-mentioned configurations of (a) and (b); however, usually, it is preferable that the polyester resin is a polyester resin composed of a diol and a dicarboxylic acid, a polyester resin composed of a diol and a hydroxycarboxylic acid, a polyester resin composed of a diol, a dicarboxylic acid, and a hydroxycarboxylic acid, or a mixture of these polyester resins.

Here, the diol as a raw material component of the polyester resin may be at least one of aliphatic diols such as ethylene glycol, diethylene glycol, propanediol, butanediol, neopentyl glycol, and hexanediol; alicyclic diols such as 1,4-hexanedimethanol; and aromatic diols. Among these, ethylene glycol, diethylene glycol, and 1,4-hexanedimethanol are particularly preferred.

The dicarboxylic acid as a compound component of the same polyester resin may be at least one of fatty acid dicarboxylic acids such as adipic acid, sebacic acid, and azelaic acid; aromatic dicarboxylic acids such as terephthalic acid, naphthalenedicarboxylic acid, and isophthalic acid; alicyclic dicarboxylic acids such as 1,4-cyclohexanedicarboxylic acid; or ester-forming derivatives of these.

Among these, terephthalic acid is particularly preferred.

The hydroxycarboxylic acid as a compound component of the same polyester resin may be at least one of lactic acid, hydroxybutyric acid, and polycaprolactone.

As a non-crystalline polyester resin, for example, a non-crystalline polyester resin composed of dicarboxylic acids including at least 80 mol % of terephthalic acid, and diols composed of 50 mol % to 80 mol % of ethylene glycol and 20 mol % to 50 mol % of one or more selected from 1,4-cyclohexanedimethanol, neopentyl glycol, and diethylene glycol, can be suitably used.

In order to change the property of the film as needed, other dicarboxylic acids and diols or hydroxycarboxylic acids may also be used. Each of these components may be used singly or as a mixture.

On the other hand, examples of the crystalline polyester resin include polyethylene terephthalate, polyethylene naphthalate, polybutylene terephthalate, polybutylene naphthalate, and polypropylene terephthalate, and each of these may be used singly or as a mixture.

Furthermore, when the polyester resin is a mixture of a crystalline polyester resin and a non-crystalline polyester resin, in order to obtain satisfactory and appropriate breakage prevention property, heat resistance, thermal shrinkage ratio, and the like, it is preferable that the blending amount of the crystalline polyester resin has a value within a range of 10% to 70% by weight with respect to the total amount (100% by weight) of the resins constituting the heat-shrinkable polyester film.

The reason for this is that by adjusting the blending amount of the crystalline polyester resin to a value within a predetermined range in this way, a heat-shrinkable polyester film that exhibits satisfactory thermal shrinkage characteristics and has excellent breakage prevention property, can be obtained.

More specifically, it is because when the blending amount of the crystalline polyester resin has a value of less than 10% by weight, it may be difficult to control the shrinkage ratio at a predetermined shrinkage temperature and the breakage prevention property of the heat-shrinkable polyester film.

On the other hand, it is because when the blending amount of the crystalline polyester resin is more than 70% by weight, not only sufficient thermal shrinkage ratios may not be obtained at a predetermined shrinkage temperature, but also a range in which predetermined factors influencing the breakage prevention property can be controlled may be markedly narrowed.

Therefore, it is more preferable that the blending amount of the crystalline polyester resin has a value within a range of 15% to 60% by weight, and even more preferably a value within a range of 20% to 50% by weight, of the total amount.

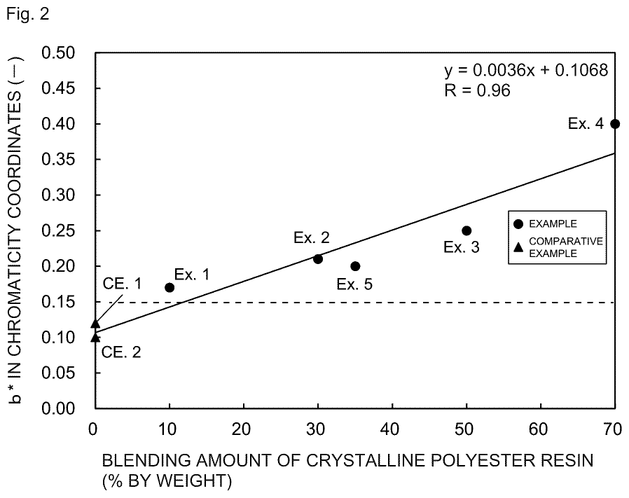

Here, referring to FIG. 2, the relationship between the blending amount of the crystalline polyester resin in the heat-shrinkable polyester film and the value of b* in the chromaticity coordinates in the CIE1976 L*a*b* color space as measured according to JIS Z 8781-4:2013 will be described.

That is, the axis of abscissa in FIG. 2 represents, for example, the blending amount (% by weight) of the crystalline polyester resin in a heat-shrinkable polyester film having a thickness of 30 μm, and the axis of ordinate represents the value of b* in the CIE chromaticity coordinates.

In the diagram, Example 1 is described as Ex. 1, while Comparative Example 1 is described as CE. 1, and the same applies hereinafter.

From the characteristic curve in FIG. 2, it is understood that there is an excellent correlation (correlation coefficient (R) is 0.96) in the relationship between the blending amount of such a crystalline polyester resin and the value of b* in the CIE chromaticity coordinates.

Therefore, it can be said that by limiting the blending amount of such a crystalline polyester resin, the value of b* in the CIE chromaticity coordinates is also easily controlled to be within a predetermined range.

Conversely, it is understood that by limiting b* in the CIE chromaticity coordinates to a value within a predetermined range (0.15 to 0.5), the blending amount of the crystalline polyester resin and the like in the heat-shrinkable polyester film can be controlled more accurately, though indirectly.

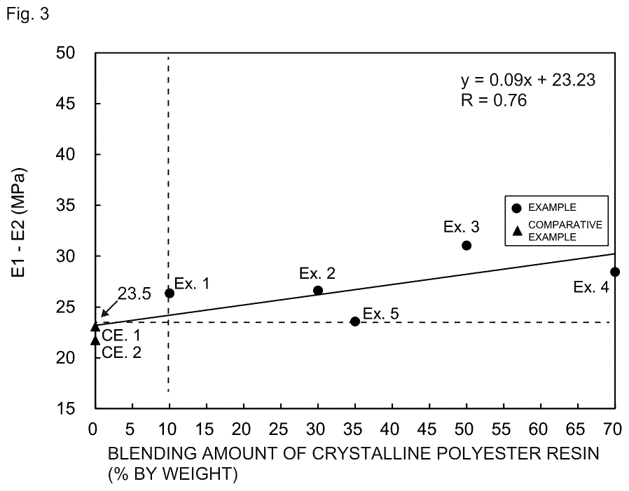

Next, referring to FIG. 3, the relationship between the blending amount of the crystalline polyester resin in the heat-shrinkable polyester film and the value of E1−E2, which is the difference between the upper yield point stress E1 and the lower yield point stress E2 in an SS curve in the MD direction, will be described.

That is, the axis of abscissa in FIG. 3 represents the blending amount (% by weight) of the crystalline polyester resin, and the axis of ordinate represents the value of E1−E2 (MPa), which is the difference between the upper yield point stress E1 and the lower yield point stress E2 in the SS curve.

From the characteristic curve in FIG. 3, as the blending amount of the crystalline polyester resin increases, the numerical value represented by E1−E2 tends to increase.

Therefore, it can be said that by limiting the blending amount of the crystalline polyester resin, the numerical value represented by E1−E2, which is the difference between the upper yield point stress E1 and the lower yield point stress E2, is also easily controlled to be within a predetermined range.

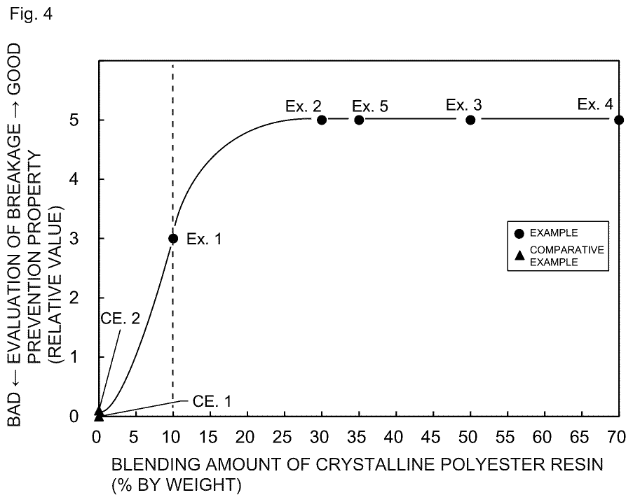

Next, referring to FIG. 4, the relationship between the blending amount of the crystalline polyester resin in the heat-shrinkable polyester film and the rating (relative value) of the breakage prevention property will be described.

That is, the axis of abscissa in FIG. 4 represents the blending amount (% by weight) of the crystalline polyester resin, and the axis of ordinate represents the rating (relative value) of the breakage prevention property.

The ratings (relative values) of the breakage prevention property are numerically expressed such that the rating ⊙ obtained in Example 1 and the like is 5 points, the rating O is 3 points, the rating Δ is 1 point, and the rating x is 0 points.

From the characteristic curve in FIG. 4, it is understood that when the blending amount of the crystalline polyester resin has a value within a range of 10% to 70% by weight, the rating (relative value) of the breakage prevention property is 3 or more points, and satisfactory breakage prevention property is obtained.

Therefore, it can be said that by limiting the blending amount of the crystalline polyester resin to a value within a predetermined range (10% to 70% by weight), the breakage prevention property of the heat-shrinkable polyester film can also be controlled accurately.

### 2. Configuration (a)

Configuration (a) is an essential configuration requirement to the effect that with regard to the heat-shrinkable polyester film of the first embodiment, when the upper yield point stress in a stress-strain curve (SS curve) in the MD direction is designated as E1 (MPa), and the lower yield point stress is designated as E2 (MPa), the value of E1−E2 satisfies a predetermined relational expression (1).

The reason for this is that satisfactory thermal shrinkage characteristics can be exhibited, and at the same time, excellent breakage prevention property can be obtained.

More specifically, it is because when the numerical value represented by E1−E2 has a value of less than 23.5 MPa or conversely has a value of more than 50 MPa, changes in the physical properties of the film cannot be sufficiently suppressed, satisfactory storage stability cannot be obtained, and satisfactory breakage prevention property also cannot be exhibited.

Therefore, it is more preferable that the numerical value represented by E1−E2 has a value within a range of 25 to 40 MPa, and even more preferably a value within a range of 26 to 35 MPa.

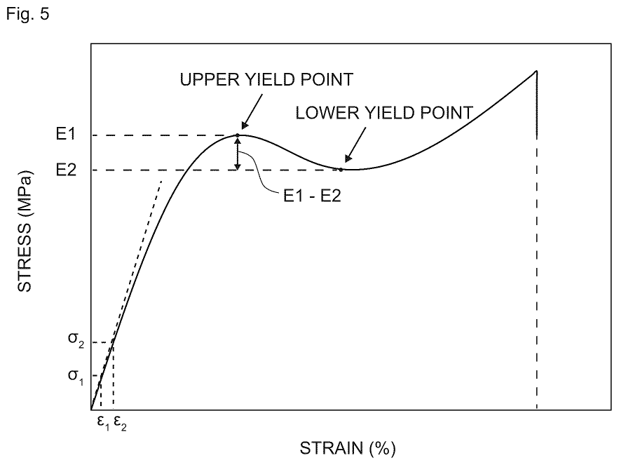

Here, referring to FIG. 5, a typical example of the SS curve in the MD direction of the heat-shrinkable polyester film in a tensile test under predetermined heating conditions (test temperature: 23° C., test speed: 200 mm/min), which is measured according to JIS K 7127:1999, will be described.

That is, the axis of abscissa in FIG. 5 represents the value of strain (%) in the MD direction of the heat-shrinkable polyester film, and the axis of ordinate represents the stress (MPa) corresponding to the strain.

From the characteristic curve (SS curve) in FIG. 5, it is understood that when the strain in the MD direction of the heat-shrinkable polyester film is increased, stress occurs correspondingly thereto, and the value of the stress also increases.

Here, the tensile modulus of elasticity (C) is also referred to as Young's modulus and can be determined as a gradient of a straight line in the SS curve, and the tensile modulus of elasticity (C) is defined by the following relational expression (2) from the stresses (σ₁ and σ₂) corresponding to the microstrains (ε₁ and ε₂) at two points in FIG. 5.

$$C = ( {σ}_{2} - {σ}_{1} ) / ( {ε}_{2} - {ε}_{1} ) \qquad ( 2 )$$

Next, when the strain in the MD direction is further increased, crystal transition of the heat-shrinkable polyester film occurs, and an upwardly protruding broad peak appears. This is the stress corresponding to the peak and is defined as upper yield point stress (E1).

Next, when the strain in the MD direction is further increased, crystal transition of the heat-shrinkable polyester film occurs again, and a downwardly protruding broad peak appears. This is the stress corresponding to the peak and is defined as lower yield point stress (E2).

The present invention is to find a predetermined relationship between the difference (E1−E2) between the upper yield point stress and the lower yield point stress of the heat-shrinkable polyester film and the breakage prevention property and the like of a label during transportation and storage after the heat-shrinkable polyester film is produced into a shrink label and is shrunk to be wrapped around a bottle, and to control the relationship.

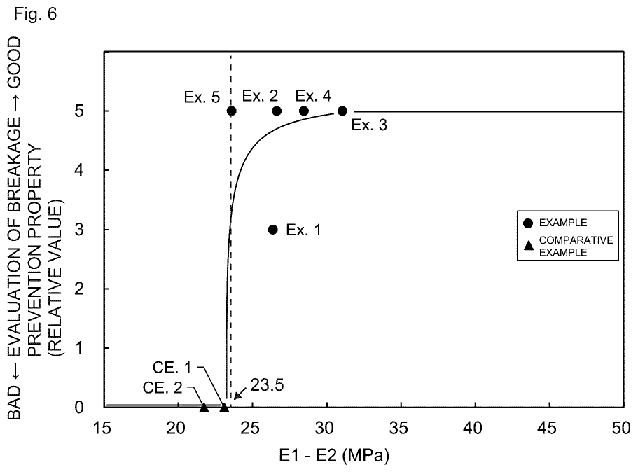

Next, referring to FIG. 6, the relationship between the value of E1−E2, which is the difference between the upper yield point stress E1 and the lower yield point stress E2, and the rating (relative value) of breakage prevention property will be described.

That is, the axis of abscissa in FIG. 6 represents the value of E1−E2 (MPa), which is the difference between the upper yield point stress E1 and the lower yield point stress E2, and the axis of ordinate represents the rating (relative value) of the breakage prevention property.

The ratings (relative values) of the breakage prevention property are numerically expressed such that the rating ⊙ obtained in Example 1 and the like is 5 points, the rating O is 3 points, the rating Δ is 1 point, and the rating x is 0 points.

From the characteristic curve in FIG. 6, it is understood that when the numerical value represented by E1−E2 is 23.5 MPa or more, the rating (relative value) of the breakage prevention property is 3 or more points, and satisfactory breakage prevention property can be obtained.

Therefore, it can be said that by limiting the numerical value represented by E1−E2 to a value within a predetermined range (23.5 to 50 MPa), the breakage prevention property of the heat-shrinkable polyester film can be controlled accurately.

In the present evaluation, it has been separately made clear that when a heat-shrinkable polyester film that exhibits satisfactory breakage prevention property is used, after the film is produced into a shrink label and shrunk to be wrapped around a bottle, the label during transportation and storage also exhibits satisfactory breakage prevention property.

### 3. Configuration (b)

Configuration (b) is a necessary configuration requirement to the effect that with regard to the heat-shrinkable polyester film of the first embodiment, a main shrinkage direction is designated as TD direction, a thermal shrinkage ratio in a case where the heat-shrinkable polyester film is shrunk in the TD direction under the conditions of 10 seconds in hot water at 98° C. is designated as A1, and this thermal shrinkage ratio A1 has a value of 30% or more.

The reason for this is that by specifically limiting the 98° C. thermal shrinkage ratio A1 to be equal to or more than a predetermined value, a satisfactory thermal shrinkage ratio is obtained for the heat-shrinkable polyester film at the time of thermal shrinkage, the numerical value represented by E1−E2 is more easily controlled to be within a predetermined range, and furthermore, satisfactory breakage prevention property is obtained.

More specifically, it is because when the 98° C. thermal shrinkage ratio A1 of the film has a value of less than 30%, the thermal shrinkage ratio is insufficient, and the heat-shrinkable polyester film may not be able to follow the shape of a PET bottle having a complicated shape when wrapped around the bottle.

Therefore, it is more preferable that the lower limit of the 98° C. thermal shrinkage ratio A1 has a value of 40% or more, and even more preferably a value of 50% or more.

On the other hand, it is because when the value of the above-mentioned 98° C. thermal shrinkage ratio A1 is excessively large, when the film is thermally shrunk, the film shrinks non-uniformly due to rapid thermal response, a breakage phenomenon is likely to occur at the time of thermal shrinkage, and it may be difficult to control the numerical value represented by E1−E2 to be within a predetermined range.

Therefore, it is preferable that the upper limit of the 98° C. thermal shrinkage ratio A1 has a value of 80% or less, more preferably a value of 75% or less, and even more preferably a value of 70% or less.

A thermal shrinkage ratio in the shrink film of the first embodiment is defined by the following formula.

Thermal shrinkage ratio (%)=(L₀−L₁)/L₀×100
L₀: Dimension (longitudinal direction or width direction) of a sample before heat treatment
L₁: Dimension (same direction as L₀) of the sample after heat treatment

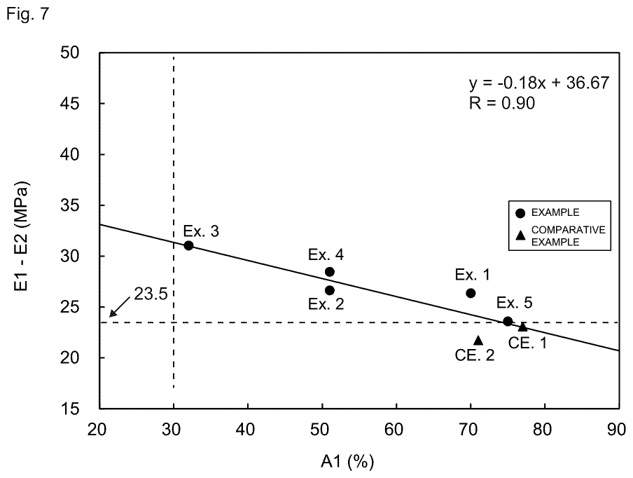

Here, referring to FIG. 7, the relationship between a shrinkage ratio (A1) of the heat-shrinkable polyester film under predetermined heating conditions (hot water at 98° C. for 10 seconds) and the difference (E1−E2) between the upper yield point stress E1 and the lower yield point stress E2 in the SS curve in the MD direction will be described.

That is, the axis of abscissa in FIG. 7 represents the value (%) of the thermal shrinkage ratio (A1) of the heat-shrinkable polyester film in the TD direction, and the axis of ordinate represents the difference (E1−E2) (MPa) between the upper yield point stress E1 and the lower yield point stress E2.

From the characteristic curve shown in FIG. 7, it is understood that there is a high correlation (correlation coefficient (R) is, for example, 0.90 by linear approximation) between the predetermined thermal shrinkage ratio A1 and the difference (E1−E2) between the upper yield point stress E1 and the lower yield point stress E2.

Therefore, it is understood that by controlling the predetermined thermal shrinkage ratio A1 at the time of thermal shrinkage, the difference (E1−E2) between the upper yield point stress and the lower yield point stress of the heat-shrinkable polyester film can also be controlled.

### 4. Optional Configuration Requirements

### (1) Configuration (c)

Configuration (c) is an optional configuration requirement to the effect that with regard to the heat-shrinkable polyester film of the first embodiment, the value of the upper yield point stress E1 is larger than the value of the lower yield point stress E2, and at the same time, E1 has a value within a range of 40 to 70 MPa, while E2 has a value within a range of 15 to 45 MPa.

That is, by specifically limiting the values of the upper yield point stress E1 and the lower yield point stress E2 in the SS curve in the MD direction, the numerical value represented by E1−E2, which is the difference between the upper yield point stress E1 and the lower yield point stress E2, can be more easily controlled to be within a predetermined range, and a shrink film having excellent breakage prevention property can be obtained.

Therefore, it is more preferable that the upper yield point stress E1 has a value within a range of 45 to 65 MPa, and even more preferably a value within a range of 50 to 60 MPa.

Furthermore, it is more preferable that the lower yield point stress E2 has a value within a range of 20 to 40 MPa, and even more preferably a value within a range of 25 to 35 MPa.

### (2) Configuration (d)

Configuration (d) is an optional configuration requirement to the effect that with regard to the heat-shrinkable polyester film of the first embodiment, the thermal shrinkage ratio in a case where the heat-shrinkable polyester film is shrunk under the conditions of 10 seconds in hot water at 80° C. is designated as A2, and the A2 has a value of 51% or less.

That is, by specifically limiting the 80° C. thermal shrinkage ratio A2 to be equal to or less than a predetermined value, for the heat-shrinkable polyester film at the time of thermal shrinkage, the numerical value represented by E1−E2 can be more easily controlled to be within a predetermined range while maintaining a satisfactory thermal shrinkage ratio, and in addition, satisfactory breakage prevention property can be obtained.

More specifically, when the 80° C. thermal shrinkage ratio A2 of the film has a value of more than 518, when the film is thermally shrunk, the film may shrink non-uniformly due to rapid thermal response so that a breakage phenomenon is likely to occur at the time of thermal shrinkage, it may be difficult to control the numerical value represented by E1−E2 to be within a predetermined range, and after the heat-shrinkable polyester film is produced into a shrink label and is shrunk to be wrapped around a bottle, the breakage prevention property of the label during transportation and storage may be deteriorated.

Therefore, it is more preferable that the 80° C. thermal shrinkage ratio A2 has a value of 48% or less, and even more preferably a value of 45% or less.

However, when the above-mentioned 80° C. thermal shrinkage ratio A2 is excessively small, the thermal shrinkage ratio may be insufficient, and the heat-shrinkable polyester film may not be able to follow the shape of a PET bottle having a complicated shape when wrapped around the bottle.

Therefore, it is preferable that the lower limit of the 80° C. thermal shrinkage ratio A2 has a value of 15% or more, more preferably a value of 20% or more, and even more preferably a value of 25% or more.

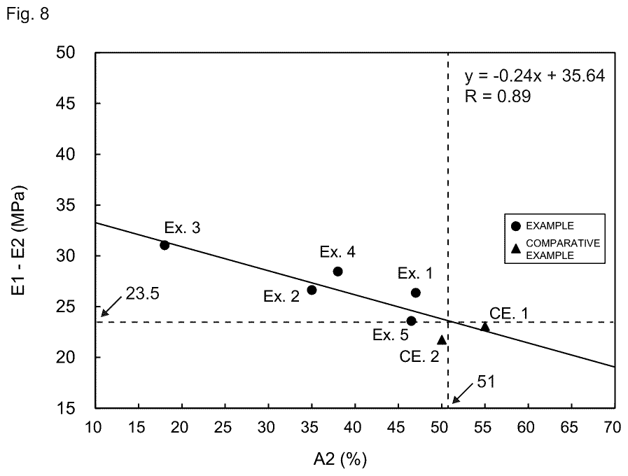

Here, referring to FIG. 8, the relationship between a shrinkage ratio (A2) of the heat-shrinkable polyester film under predetermined heating conditions (hot water at 80° C. for 10 seconds) and the difference (E1−E2) between the upper yield point stress E1 and the lower yield point stress E2 in the SS curve in the MD direction, will be described.

That is, the axis of abscissa in FIG. 8 represents the value (%) of the thermal shrinkage ratio (A2) in the TD direction of the heat-shrinkable polyester film, and the axis of ordinate represents the difference (E1−E2) (MPa) between the upper yield point stress E1 and the lower yield point stress E2.

From the characteristic curve shown in FIG. 8, it is understood that there is a high correlation (correlation coefficient (R) is, for example, 0.89 by linear approximation) between the predetermined thermal shrinkage ratio A2 and the difference (E1−E2) between the upper yield point stress E1 and the lower yield point stress E2.

Therefore, it is understood that by controlling the predetermined thermal shrinkage ratio A2 at the time of thermal shrinkage, the difference (E1−E2) between the upper yield point stress and the lower yield point stress of the heat-shrinkable polyester film can also be controlled.

### (3) Configuration (e)

Configuration (e) is an optional configuration requirement to the effect that with regard to the heat-shrinkable polyester film of the first embodiment, when a thermal shrinkage in the TD direction is designated as A3, the A3 has a value of 20% or less.

That is, by specifically limiting the thermal shrinkage ratio A3 in hot water at 70° C. for 10 seconds to be equal to or less than a predetermined value, a stable thermal shrinkage ratio can be obtained at 80° C. to 100° C., the numerical value represented by E1−E2 can be more easily controlled to be within a predetermined range, and satisfactory breakage prevention property can be obtained.

More specifically, when such a thermal shrinkage ratio A3 has a value of more than 20%, not only it may be difficult to obtain a stable thermal shrinkage ratio at 80° C. to 100° C., but also it is difficult to control the numerical value represented by E1−E2 to be within in a predetermined range, and satisfactory breakage prevention property may not be obtained.

Therefore, it is more preferable that the upper limit of the thermal shrinkage ratio A3 has a value of 15% or less, and even more preferably a value of 10% or less.

However, when the thermal shrinkage ratio A3 is excessively small, the thermal shrinkage ratio is insufficient at 80° C. to 100° C., and the heat-shrinkable polyester film may not be able to follow the shape of a PET bottle having a complicated shape when wrapped around the bottle.

Therefore, it is more preferable that the lower limit of the thermal shrinkage ratio A3 has a value of 1% or more, and even more preferably a value of 3% or more.

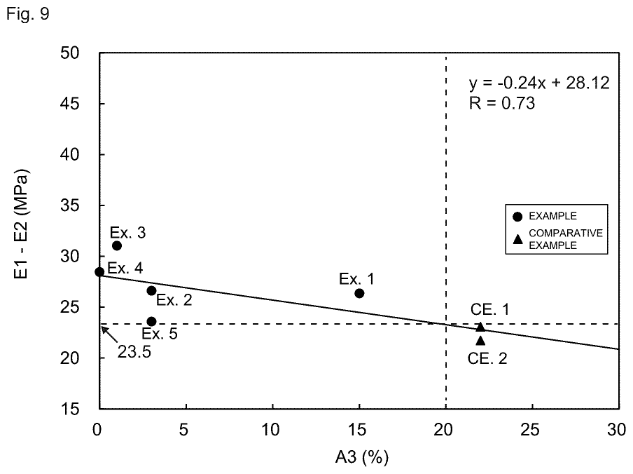

Here, referring to FIG. 9, the relationship between a shrinkage ratio (A3) of the heat-shrinkable polyester film under predetermined heating conditions (hot water at 70° C. for 10 seconds) and the difference (E1−E2) between the upper yield point stress E1 and the lower yield point stress E2 in the SS curve in the MD direction, will be described.

That is, the axis of abscissa in FIG. 9 represents the value (%) of the thermal shrinkage ratio (A3) in the TD direction of the heat-shrinkable polyester film, and the axis of ordinate represents the difference (E1−E2) (MPa) between the upper yield point stress E1 and the lower yield point stress E2.

From the characteristic curve shown in FIG. 9, it is understood that there is a high correlation (correlation coefficient (R) is, for example, 0.73 by linear approximation) between the predetermined thermal shrinkage ratio A3 and the difference (E1−E2) between the upper yield point stress E1 and the lower yield point stress E2.

Therefore, it is understood that by controlling the predetermined thermal shrinkage ratio A3 at the time of thermal shrinkage, the difference (E1−E2) between the upper yield point stress and the lower yield point stress of the heat-shrinkable polyester film can also be controlled.

### (4) Configuration (f)

Configuration (f) is an optional configuration requirement to the effect that with regard to the heat-shrinkable polyester film of the first embodiment, when the tensile modulus of elasticity in the MD direction as measured according to JIS K 7127:1999 is designated as C, the C has a value within a range of 1400 to 1800 MPa.

That is, by specifically limiting the tensile modulus of elasticity in the MD direction to a value within a predetermined range in this way, the numerical value represented by E1−E2 can be easily controlled to be within a predetermined range, and furthermore, the breakage prevention property can be improved.

More specifically, when the tensile modulus of elasticity C in the MD direction is less than 1400 MPa, the numerical value represented by E1−E2 cannot be controlled to a value within a predetermined range, and furthermore, satisfactory breakage prevention property may be deteriorated.

On the other hand, when the tensile modulus of elasticity C in the MD direction is more than 1800 MPa, the type of the polyester resin that can be used may be excessively limited, or it may be difficult to stably control the numerical value represented by E1−E2, and the product yield in production may be markedly decreased.

Therefore, as configuration (f), it is more preferable that the tensile modulus of elasticity C in the MD direction is 1450 to 1700 MPa, and even more preferably a value within a range of 1480 to 1650 MPa.

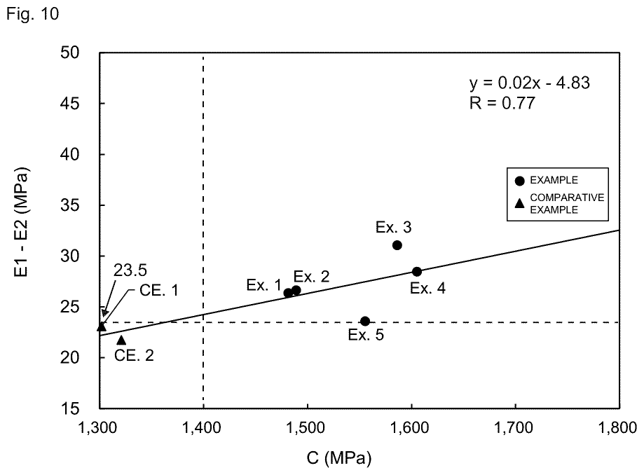

Here, referring to FIG. 10, the relationship between the tensile modulus of elasticity C in the MD direction and the value of E1−E2, which is the difference between the upper yield point stress E1 and the lower yield point stress E2, will be described.

That is, the axis of abscissa in FIG. 10 represents the tensile modulus of elasticity C (MPa) in the MD direction, and the axis of ordinate represents the value of E1−E2 (MPa), which is the difference between the upper yield point stress E1 and the lower yield point stress E2.

From the characteristic curve shown in FIG. 10, it is understood that when the tensile modulus of elasticity C is 1400 MPa or more, the numerical value represented by E1-E2 can be controlled to 23.5 MPa or more.

Therefore, it can be said that by limiting the tensile modulus of elasticity C of the heat-shrinkable polyester film as measured in Example 1 and the like that will be described below, the numerical value represented by E1−E2 is also easily controlled.

### (5) Configuration (g)

Configuration (g) is an optional configuration requirement to the effect that with regard to the heat-shrinkable polyester film of the first embodiment, b* in the chromaticity coordinates in the CIE1976 L*a*b* color space as measured according to JIS Z 8781-4:2013 has a value within a range of 0.15 to 0.5.

That is, when the value of b* in the CIE chromaticity coordinates is less than 0.15, the blending amount of the crystalline polyester resin and the like is decreased, though relatively, and it may be difficult to control the numerical value represented by E1−E2 to be within a predetermined range.

On the other hand, when b* in the CIE chromaticity coordinates has a value of more than 0.5, not only the transparency feeling of the heat-shrinkable polyester film is decreased, but also the blending amount of the crystalline polyester resin and the like is excess, though relatively, and the values of thermal shrinkage ratios may be markedly decreased.

Therefore, it is more preferable that b′ in the CIE chromaticity coordinates has a value within a range of 0.2 to 0.4, and even more preferably a value within a range of 0.22 to 0.36.

### (6) Configuration (h)

Configuration (h) is an optional configuration requirement to the effect that with regard to the heat-shrinkable polyester film of the first embodiment, the thickness (average thickness) of the film before thermal shrinkage has a value usually within a range of 10 to 100 μm.

That is, it is because, by specifically limiting the thickness of the film before thermal shrinkage to a value within a predetermined range, each of the thermal shrinkage ratios A1 to A3, the upper yield point stress E1, the lower yield point stress E2, the numerical value represented by E1−E2, and the like can be more easily controlled to a value within a predetermined range.

Therefore, the breakage prevention property of the heat-shrinkable polyester film can be improved by reducing predetermined influencing factors.

Therefore, as configuration (h), it is more preferable that the thickness of the film before thermal shrinkage has a value within a range of 15 to 70 μm, and even more preferably a value within a range of 20 to 40 μm.

### (7) Configuration (i)

Configuration (i) is an optional configuration requirement to the effect that with regard to the heat-shrinkable polyester film of the first embodiment, the haze value of the film before thermal shrinkage as measured according to JIS K 7136:2000 is a value of 8% or less.

That is, by specifically limiting the haze value to a value within a predetermined range in this way, the transparency of the heat-shrinkable polyester film is also easily controlled quantitatively, and from the viewpoint of having satisfactory transparency, versatility can be further enhanced.

More specifically, when the haze value of the film before thermal shrinkage has a value of more than 8%, transparency may be decreased, and it may be difficult to apply the film to decorative use and the like for a PET bottle.

On the other hand, when the haze value of the film before thermal shrinkage is excessively small, it may be difficult to stably control the haze value, and the product yield in production may be markedly decreased.

Therefore, it is more preferable that the haze value of the film before thermal shrinkage as the configuration (i) has a value within a range of 0.1% to 6%, and even more preferably a value within a range of 0.5% to 5%.

### (8) Others

It is preferable that various additives are blended into the heat-shrinkable polyester film of the first embodiment or into one surface or both surfaces of the film, or those various additives are attached thereto. More specifically, it is preferable that at least one of a hydrolysis inhibitor, an antistatic agent, an ultraviolet absorber, an infrared absorber, a colorant, an organic filler, an inorganic filler, organic fibers, inorganic fibers, and the like is blended usually in an amount in a range of 0.01% to 10% by weight, and more preferably blended in an amount in a range of 0.1% to 18 by weight, with respect to the total amount of the heat-shrinkable polyester film.

As shown in FIG. 1B, it is also preferable that other resin layers 10a and 10b including at least one of these various additives are laminated on one surface or both surfaces of the heat-shrinkable polyester film 10.

In that case, when the thickness of the heat-shrinkable polyester film is taken as 100%, it is preferable that the single layer thickness or the total thickness of the other resin layers that are additionally laminated has a value usually within a range of 0.1% to 10%.

The resin as a main component constituting the other resin layers may be the same polyester resin as that of the heat-shrinkable polyester film, or it is preferable that the resin is at least one of an acrylic resin, an olefin resin, a urethane resin, a rubber resin, and the like, which are different from the polyester resin.

In addition, it is also preferable that a hydrolysis preventing effect or mechanical protection is further improved by producing the heat-shrinkable polyester film into a multilayer structure, or as shown in FIG. 1C, a shrinkage ratio adjusting layer 10c is provided on the surface of the heat-shrinkable polyester film 10 so that the shrinkage ratio of the heat-shrinkable polyester film is uniform in the plane.

Such a shrinkage ratio adjusting layer can be laminated by using an adhesive, a coating method, a heating treatment, or the like depending on the shrinkage characteristics of the heat-shrinkable polyester film.

More specifically, the thickness of the shrinkage ratio adjusting layer is in a range of 0.1 to 3 μm, and when the shrinkage ratio of the heat-shrinkable polyester film at a predetermined temperature is excessively large, it is preferable to laminate a shrinkage ratio adjusting layer of a type that suppresses the large shrinkage ratio.

Furthermore, when the shrinkage ratio of the heat-shrinkable polyester film at a predetermined temperature is excessively small, it is preferable to laminate a shrinkage ratio adjusting layer of a type that increases the small shrinkage ratio.

Therefore, it is intended to obtain a desired shrinkage ratio by using a shrinkage ratio adjusting layer without producing various shrink films having different shrinkage ratios as the heat-shrinkable polyester film.

### Second Embodiment

A second embodiment is an embodiment related to a method for producing the heat-shrinkable polyester film of the first embodiment.

### 1. Raw Material Preparation and Mixing Step

First, it is preferable to prepare main agents and additives, such as a non-crystalline polyester resin, a crystalline polyester resin, a rubber resin, an antistatic agent, and a hydrolysis inhibitor, as raw materials.

Next, it is preferable that the prepared non-crystalline polyester resin, crystalline polyester resin, and the like are introduced into a stirring vessel while being weighed, and the raw materials are mixed and stirred using a stirring device until the mixture becomes uniform.

### 2. Original Sheet Production Step

Next, it is preferable that the uniformly mixed raw materials are dried into an absolutely dry state.

Next, typically, it is preferable to perform extrusion molding and produce an original sheet before stretching (sometimes simply called as original sheet) having a predetermined thickness.

More specifically, for example, extrusion molding is performed by using an extruder (manufactured by TANABE PLASTICS MACHINERY CO., LTD.) with L/D 24 and an extrusion screw diameter of 50 mm under the conditions of an extrusion temperature of 245° C., and an original sheet having a predetermined thickness (usually, 30 to 1000 μm) can be obtained.

### 3. Production of Heat-Shrinkable Polyester Film

Next, the obtained original sheet is heated and pressed while being moved on rolls and between rolls by using a shrink film production apparatus to produce a heat-shrinkable polyester film.

That is, it is preferable that polyester molecules constituting the heat-shrinkable polyester film are crystallized into a predetermined shape by stretching the original sheet in a predetermined direction while basically extending the film width at a predetermined stretching temperature and stretching ratio and while heating and pressing the film.

Then, by solidifying the resultant in that state, a heat-shrinkable polyester film that is used as decorations, labels, and the like can be produced.

### (1) Stretch Ratio in MD Direction

It is preferable that the stretch ratio in the MD direction (average MD direction stretch ratio, may be simply referred to as MD direction stretch ratio) of the heat-shrinkable polyester film before thermal shrinkage has a value within a range of 100% to 200%.

The reason for this is that by specifically limiting the MD direction stretch ratio to a value within a predetermined range in this way and specifically limiting each of the thermal shrinkage ratios A1 to A3, the upper yield point stress E1, the lower yield point stress E2, the numerical value represented by E1−E2, the tensile modulus of elasticity C, and the like to a value within a predetermined range, after the heat-shrinkable polyester film is produced into a shrink label and is shrunk to be wrapped around a bottle, the breakage prevention property of the label during transportation and storage can be improved.

More specifically, it is because when the MD direction stretch ratio has a value of less than 100%, the product yield in production may be markedly decreased.

On the other hand, it is because when the MD direction stretch ratio is more than 2008, the shrinkage ratio in the TD direction is affected, and adjustment of the shrinkage ratio itself may be difficult.

Therefore, it is more preferable that the MD direction stretch ratio has a value within a range of 100% to 150%, and even more preferably a value within a range of 100% to 120%.

### (2) Stretch Ratio in TD Direction

It is also preferable that the stretch ratio in the TD direction (average TD direction stretch ratio, may be simply referred to as TD direction stretch ratio) of the heat-shrinkable polyester film before thermal shrinkage has a value within a range of 300% to 600%.

The reason for this is that by specifically limiting not only the above-mentioned MD direction stretch ratio but also the TD direction stretch ratio to values within predetermined ranges, and specifically limiting each of the thermal shrinkage ratios A1 to A3, the upper yield point stress E1, the lower yield point stress E2, the numerical value represented by E1−E2, the tensile modulus of elasticity C, and the like to a value within a predetermined range, after the heat-shrinkable polyester film is produced into a shrink label and is shrunk to be wrapped around a bottle, the breakage prevention property of the label during transportation and storage can be even further improved.

More specifically, it is because when the TD direction stretch ratio has a value of less than 300%, the shrinkage ratio in the TD direction may be markedly decreased, and the use applications of the heat-shrinkable polyester film available for use may be excessively limited.

On the other hand, it is because when the TD direction stretch ratio has a value of more than 600%, the thermal shrinkage ratio may be markedly increased, and the use applications of the heat-shrinkable polyester film available for use may be excessively limited, or it may be difficult to control the stretch ratio itself to be constant.

Therefore, it is more preferable that the TD direction stretch ratio has a value within a range of 350% to 550%, and even more preferably a value within a range of 400% to 500%.

### 4. Heat-Shrinkable Polyester Film Inspection Step

It is preferable that the following characteristics and the like are measured continuously or intermittently for the produced heat-shrinkable polyester film, and a predetermined inspection step is provided.

That is, by measuring the following characteristics and the like by a predetermined inspection step and checking whether the values fall within predetermined ranges, a heat-shrinkable polyester film having more uniform shrinkage characteristics and the like can be obtained.
1) Examination by visual inspection on the appearance of the heat-shrinkable polyester film
2) Measurement of variation in thickness
3) Measurement of tensile modulus of elasticity
4) Measurement of tear strength
5) Measurement of viscoelasticity characteristics using an SS curve

For the production of the heat-shrinkable polyester film of the second embodiment, the heat-shrinkable polyester film is a heat-shrinkable polyester film derived from a polyester resin composition including a crystalline polyester resin in an amount in a range of 10% to 70% by weight with respect to the total resin amount, and when the main shrinkage direction is designated as TD direction, and a direction orthogonally intersecting the TD direction is designated as MD direction, it is important to measure the following configurations (a) and (b) and check whether the values are within predetermined ranges.
(a) When the upper yield point stress in the stress-strain curve in the MD direction is designated as E1 (MPa), and the lower yield point stress is designated as E2 (MPa), the value of E1−E2 satisfies the following relational expression (1):

$$23.5 \leq E 1 - E 2 \leq 50 \qquad ( 1 )$$

(b) When the thermal shrinkage ratio in a case where the heat-shrinkable polyester film is shrunk in the TD direction under the conditions of 10 seconds in hot water at 98° C. is designated as A1, the A1 has a value of 30% or more.

### Third Embodiment

A third embodiment is an embodiment related to a method of using a heat-shrinkable polyester film.

Therefore, that is, known methods of using shrink films can all be suitably applied.

For example, upon carrying out a method of using a heat-shrinkable polyester film, first, the heat-shrinkable polyester film is cut into an appropriate length or width, and at the same time, a long tubular-shaped object is formed.

Next, this long tubular-shaped object is supplied to an automatic label wrapping apparatus (shrink labeler) and further cut into a required length.

Next, the long tubular-shaped object is fitted onto a PET bottle filled with contents.

Next, as a heating treatment for the heat-shrinkable polyester film fitted onto a PET bottle or the like, the PET bottle or the like is passed through the inside of a hot air tunnel or a steam tunnel at a predetermined temperature.

Then, by blowing radiant heat such as infrared radiation or heated steam at about 90° C. provided in these tunnels from the surroundings, the heat-shrinkable polyester film is uniformly heated and thermally shrunk.

Therefore, a labeled container can be quickly obtained by closely attaching the heat-shrinkable polyester film to the outer surface of the PET bottle or the like.

That is, according to the heat-shrinkable polyester film of the present invention, as described above in the first embodiment, there is provided a heat-shrinkable polyester film derived from a polyester resin composition including a crystalline polyester resin in an amount in a range of 10% to 70% by weight with respect to the total resin amount, the heat-shrinkable polyester film satisfying at least configurations (a) and (b).

By doing so, after the heat-shrinkable polyester film is produced into a shrink label and is shrunk to be wrapped around a bottle, the breakage prevention property of the label during transportation and storage can be improved.

### EXAMPLES

Hereinafter, the present invention will be described in detail on the basis of Examples. However, the scope of rights of the present invention is not to be limited by the description of Examples and the like, without any particular reason.

The polyester resins and the like used in the Examples and the like are as follows.

### (PETG1)

A non-crystalline polyester composed of dicarboxylic acid: 100 mol % of terephthalic acid, diol: 63 mol % of ethylene glycol, 13 mol % of diethylene glycol, and 24 mol % of 1,4-cyclohexanedimethanol

### (PETG2)

A non-crystalline polyester composed of dicarboxylic acid: 100 mol % of terephthalic acid, diol: 68 mol % of ethylene glycol, 22 mol % of 1,4-cyclohexanedimethanol, and 10 mol % of diethylene glycol

### (PETG3)

A non-crystalline polyester composed of dicarboxylic acid: 100 mol % of terephthalic acid, diol: 70 mol % of ethylene glycol, 28 mol % of neopentyl glycol, and 2 mol % of diethylene glycol

### (APET)

A crystalline polyester composed of dicarboxylic acid: 100 mol % of terephthalic acid, diol: 100 mol % of ethylene glycol

### (PBT)

A crystalline polyester composed of dicarboxylic acid: 100 mol % of terephthalic acid, diol: 100 mol % of 1,4-butanediol

### (Additive (Anti-Blocking Agent))

A silica masterbatch composed of matrix resin: PET, silica content: 5% by mass, average particle size of silica: 2.7 μm

### Example 1

### 1. Production of Heat-Shrinkable Polyester Film

90 parts by weight (pbw) of a non-crystalline polyester resin (PETG1), 10 parts by weight of a crystalline polyester resin (A-PET), and 0.8 parts by weight of a predetermined additive (anti-blocking agent) were placed in a stirring vessel.

Next, these raw materials were brought into an absolutely dry state, subsequently extrusion molding was performed by using an extruder (manufactured by TANABE PLASTICS MACHINERY CO., LTD.) with L/D 24 and an extrusion screw diameter of 50 mm under the conditions of an extrusion temperature of 245° C., and an original sheet having a thickness of 150 μm was obtained.

Next, a heat-shrinkable polyester film having a thickness of 30 μm was produced from the original sheet by using a shrink film production apparatus at a preliminary heating temperature of 80° C., a stretching temperature of 80° C., a thermal fixation temperature of 78° C., and stretch ratios (MD direction: 100%, TD direction: 500%).

### 2. Evaluation of Heat-Shrinkable Polyester Film

### (1) Evaluation 1: Variation in Thickness

The thickness (taking the desired value 30 μm as a reference value) of the obtained heat-shrinkable polyester film was measured by using a micrometer and was evaluated according to the following criteria as Eva 1.

⊙ (Very good): The variation in thickness is a value within a range of (reference value±0.1 μm).

O (Good): The variation in thickness is a value within a range of (reference value±0.5 μm).

Δ (Fair): The variation in thickness is a value within a range of (reference value±1.0 μm).

x (Bad): The variation in thickness is a value within a range of (reference value±3.0 μm).

### (2) Evaluation 2: Yield Point Stresses (E1 and E2)

The upper yield point stress E1 and the lower yield point stress E2 in an SS curve in the MD direction of the obtained heat-shrinkable polyester film were measured.

The value of E1−E2 was calculated from the obtained upper yield point stress E1 and lower yield point stress E2 and was used for each evaluation as Eva 2.

### (2)-1 Evaluation 2-1: Upper Yield Point Stress (E1)

The measured upper yield point stress (E1) was evaluated according to the following criteria.

⊙ (Very good): The upper yield point stress (E1) has a value within a range of 45 to 65 MPa.

O (Good): The upper yield point stress (E1) is outside the above-described range and has a value within a range of 40 to 70 MPa.

Δ (Fair): The upper yield point stress (E1) is outside the above-described range and has a value within a range of 35 to 75 MPa.

x (Bad): The upper yield point stress (E1) has a value of less than 35 MPa or more than 75 MPa.

### (2)-2 Evaluation 2-2: Lower Yield Point Stress (E2)

The measured lower yield point stress (E2) was evaluated according to the following criteria.

⊙ (Very good): The lower yield point stress (E2) has a value within a range of 20 to 40 MPa.

O (Good): The lower yield point stress (E2) is outside the above-described range and has a value within a range of 15 to 45 MPa.

Δ (Fair): The lower yield point stress (E2) is outside the above-described range and has a value within a range of 10 to 50 MPa.

x (Bad): The lower yield point stress (E2) has a value of less than 10 MPa or more than 50 MPa.

### (2)-3 Evaluation 2-3: E1−E2

The calculated value of E1−E2 were evaluated according to the following criteria.

⊙ (Very good): E1−E2 has a value within a range of 25 to 40 MPa.

O (Good): E1−E2 is outside the above-described range and has a value within a range of 23.5 to 50 MPa.

Δ (Fair): E1−E2 is outside the above-described range and has a value within a range of 22 to 60 MPa.

x (Bad): E1−E2 has a value of less than 22 MPa or more than 60 MPa.

### (3) Evaluation 3: Thermal Shrinkage Ratio (A1)

The obtained heat-shrinkable polyester film (TD direction) was immersed in hot water at 98° C. for 10 seconds by using a constant-temperature water bath and was thermally shrunk.

Next, from the dimensional changes occurred before and after a heating treatment at a predetermined temperature (hot water at 98° C.), the thermal shrinkage ratio (A1) was calculated according to the following Formula (3) and was evaluated according to the following criteria as Eva 3.

$$Thermal shrinkage ratio = \frac{( Length of film before thermal shrinkage - Length of film after thermal shrinkage )}{( Length of film before thermal shrinkage )} \times 100 \qquad ( 3 )$$

⊙ (Very good): The thermal shrinkage ratio (A1) has a value within a range of 40% to 75%.

O (Good): The thermal shrinkage ratio (A1) is outside the above-described range and has a value within a range of 30% to 80%.

Δ (Fair): The thermal shrinkage ratio (A1) is outside the above-described range and has a value within a range of 25% to 85%.

x (Bad): The thermal shrinkage ratio (A1) has a value of less than 25% or more than 85%.

### (4) Evaluation 4: Thermal Shrinkage Ratio (A2)

The obtained heat-shrinkable polyester film (TD direction) was immersed in hot water at 80° C. for 10 seconds by using a constant-temperature water bath and was thermally shrunk.

Next, from the dimensional changes occurred before and after a heating treatment at a predetermined temperature (hot water at 80° C.), the thermal shrinkage ratio (A2) was calculated according to the above-described Formula (3) and was evaluated according to the following criteria as Eva 4.

⊙ (Very good): The thermal shrinkage ratio (A2) has a value of 48% or less.

O (Good): The thermal shrinkage ratio (A2) has a value of 51% or less.

Δ (Fair): The thermal shrinkage ratio (A2) has a value of 54% or less.

x (Bad): The thermal shrinkage ratio (A2) has a value of more than 54%.

### (5) Evaluation 5: Thermal Shrinkage Ratio (A3)

The obtained heat-shrinkable polyester film (TD direction) was immersed in hot water at 70° C. for 10 seconds by using a constant-temperature water bath and was thermally shrunk.

Next, from the dimensional changes occurred before and after a heating treatment at a predetermined temperature (hot water at 70° C.), the thermal shrinkage ratio (A3) was calculated according to the above-described Formula (3) and was evaluated according to the following criteria as Eva 5.

⊙ (Very good): The thermal shrinkage ratio (A3) has a value of 15% or less.

O (Good): The thermal shrinkage ratio (A3) has a value of 20% or less.

Δ (Fair): The thermal shrinkage ratio (A3) has a value of 25% or less.

x (Bad): The thermal shrinkage ratio (A3) has a value of more than 25%.

### (6) Evaluation 6: Tensile Modulus of Elasticity (C)

The obtained heat-shrinkable polyester film was cut into a strip form having a width in the TD direction of 10 mm and a length in the MD direction of 150 mm, and this strip form was used as a test piece.

Next, a tensile test was performed according to JIS K 7127:1999 in an atmosphere at a temperature of 23° C. and a relative humidity of 50% RH at a tensile speed of 200 mm/min, the tensile modulus of elasticity (C) in the MD direction of the prepared test piece was measured and calculated, with the strain range of the elastic modulus measurement being 0% to 1%, and the tensile modulus of elasticity was evaluated according to the following criteria.

⊙ (Very good): The tensile modulus of elasticity (C) has a value within a range of 1450 to 1700 MPa.

O (Good): The tensile modulus of elasticity (C) is outside the above-described range and has a value within a range of 1400 to 1800 MPa.

Δ (Fair): The tensile modulus of elasticity (C) is outside the above-described range and has a value within a range of 1350 to 1900 MPa.

x (Bad): The tensile modulus of elasticity (C) has a value of less than 1350 MPa or more than 1900 MPa.

### (7) Evaluation 7: Breakage Prevention Property

A cylindrical-shaped PET bottle in a state of being filled with a commercially available beverage was prepared (trade name: EVIAN, volume: 500 ml).

Next, a long-shaped shrink film obtained by slitting a heat-shrinkable polyester film into a width of 26 cm was provided with perforations having a width of 1 mm along the longitudinal direction, 1,3-dioxolane was applied at the end parts in the width direction, the end parts in the width direction were superposed and adhered such that the overlap margin was about 1 cm, and a tubular-shaped label having a diameter of about 8 cm was obtained. Furthermore, this tubular-shaped label was cut out every 5 cm in the longitudinal direction, and a plurality of tubular-shaped labels were obtained.

Next, the prepared cylindrical-shaped PET bottle was covered with the tubular-shaped label, the PET bottle was placed on a belt conveyor and moved at a passing speed of 6 m/min through the inside of a steam tunnel maintained at 85° C., and the tubular-shaped label was thermally shrunk so as to closely adhere to the cylindrical-shaped PET bottle.

Next, the label-shaped heat-shrinkable polyester film was torn at the perforations such that the label remainder width was one perforation remainder, and then the resultant was used as a sample for evaluation of breakage prevention property.

Next, the sample for evaluation was caused to fall naturally from a height of 1.5 m onto a concrete floor surface, the number of times required by the label-shaped heat-shrinkable polyester film to be cut or damaged by visual inspection was measured, and the breakage prevention property was evaluated according to the following criteria.

⊙ (Very good): The sample for evaluation withstands three or more times of drop tests.

O (Good): The sample for evaluation withstands two or more times of drop tests.

Δ (Fair): The sample for evaluation withstands one time of drop test.

x (Bad): The sample for evaluation does not withstand even one time of drop test.

### (8) Evaluation 8: CIE Chromaticity Coordinates

With regard to the obtained heat-shrinkable polyester film, b* in the chromaticity coordinates in the CIE1976 L*a*b* color space as measured according to JIS Z 8781-4:2013 was measured by using a spectrophotometer (manufactured by SHIMADZU CORPORATION, product name “UV-3600”), and the color tinge of the shrink film was evaluated according to the following criteria.

⊙ (Very good): b* in the CIE chromaticity coordinates has a value within a range of 0.2 to 0.4.

O (Good): b* in the CIE chromaticity coordinates is outside the above-described range and has a value within a range of 0.15 to 0.5.

Δ (Fair): b* in the CIE chromaticity coordinates is outside the above-described range, has a value within a range of 0.1 to 0.6, and is outside the above-described range of O.

x (Bad): b* in the CIE chromaticity coordinates has a value of less than 0.1 or more than 0.6.

### Example 2

In Example 2, as shown in Table 1, 70 parts by weight of a non-crystalline polyester resin (PETG1), 30 parts by weight of a crystalline polyester resin (A-PET), and 0.8 parts by weight of a predetermined additive (anti-blocking agent) were used.

At the same time, similarly to Example 1, a heat-shrinkable polyester film having a thickness of 30 μm was produced from the original sheet at a preliminary heating temperature of 80° C., a stretching temperature of 80° C., a thermal fixation temperature of 78° C. and stretch ratios (MD direction: 100%, TD direction: 500%).

Then, with regard to the produced heat-shrinkable polyester film, the breakage prevention property and the like were evaluated in the same manner as in Example 1. The results are shown in Table 2.

### Example 3

In Example 3, as shown in Table 1, 50 parts by weight of a non-crystalline polyester resin (PETG1), 50 parts by weight of a crystalline polyester resin (A-PET), and 0.8 parts by weight of the predetermined additive (anti-blocking agent) were used.

At the same time, similarly to Example 1, a heat-shrinkable polyester film having a thickness of 30 μm was produced from the original sheet at a preliminary heating temperature of 80° C., a stretching temperature of 80° C., a thermal fixation temperature of 78° C., and stretch ratios (MD direction: 100%, TD direction: 500%).

Then, with regard to the produced heat-shrinkable polyester film, the breakage prevention property and the like were evaluated in the same manner as in Example 1. The results are shown in Table 2.

### Example 4

In Example 4, as shown in Table 1, 30 parts by weight of a non-crystalline polyester resin (PETG1), 70 parts by weight of a crystalline polyester resin (A-PET), and 0.8 parts by weight of the predetermined additive (anti-blocking agent) were used.

At the same time, similarly to Example 1, a heat-shrinkable polyester film having a thickness of 30 μm was produced from the original sheet at a preliminary heating temperature of 80° C., a stretching temperature of 80° C., a thermal fixation temperature of 78° C., and stretch ratios (MD direction: 100%, TD direction: 500%).

Then, with regard to the produced heat-shrinkable polyester film, the breakage prevention property and the like were evaluated in the same manner as in Example 1. The results are shown in Table 2.

### Example 5

In Example 5, as shown in Table 1, 65 parts by weight of a non-crystalline polyester resin (PETG3), 25 parts by weight of a crystalline polyester resin (APET), 10 parts by weight of a crystalline polyester resin (PBT), and 1 part by weight of the predetermined additive (anti-blocking agent) were used.

At the same time, similarly to Example 1, a heat-shrinkable polyester film having a thickness of 30 μm was produced from the original sheet at a preliminary heating temperature of 87° C., a stretching temperature of 88° C., a thermal fixation temperature of 85° C., and stretch ratios (MD direction: 110%, TD direction: 500%).

Then, with regard to the produced heat-shrinkable polyester film, the breakage prevention property and the like were evaluated in the same manner as in Example 1. The results are shown in Table 2.

### Comparative Example 1

In Comparative Example 1, as shown in Table 1, a heat-shrinkable polyester film that had a low value of the configuration (a) and did not satisfy the configuration (a) was produced, a heat-shrinkable polyester film was produced and evaluated in the same manner as in Example 1, and the results are shown in Table 2.

That is, 100 parts by weight of a non-crystalline polyester resin (PETG1) and 0.8 parts by weight of a predetermined additive (anti-blocking agent) were used.

At the same time, similarly to Example 1, a heat-shrinkable polyester film having a thickness of 30 μm was produced from the original sheet at a preliminary heating temperature of 90° C., a stretching temperature of 83° C., a thermal fixation temperature of 81° C., and stretch ratios (MD direction: 100%, TD direction: 500%).

Then, with regard to the produced heat-shrinkable polyester film, the breakage prevention property and the like were evaluated in the same manner as in Example 1. The results are shown in Table 2.

### Comparative Example 2

In Comparative Example 2, as shown in Table 1, a heat-shrinkable polyester film that had a low value of the configuration (a) and did not satisfy the configuration (a) was produced, a heat-shrinkable polyester film was produced and evaluated in the same manner as in Example 1, and the results are shown in Table 2.

That is, 100 parts by weight of a non-crystalline polyester resin (PETG2) and 0.8 parts by weight of a predetermined additive (anti-blocking agent) were used.

At the same time, similarly to Example 1, a heat-shrinkable polyester film having a thickness of 30 μm was produced from the original sheet at a preliminary heating temperature of 90° C., a stretching temperature of 83° C., a thermal fixation temperature of 81° C., and stretch ratios (MD direction: 100%, TD direction: 500%).

Then, with regard to the produced heat-shrinkable polyester film, the breakage prevention property and the like were evaluated in the same manner as in Example 1. The results are shown in Table 2.

TABLE 1

| | | | | | | | Preliminary | | Thermal | MD | TD |
|---|---|---|---|---|---|---|---|---|---|---|---|
| | | | | | | | heating | Stretching | fixation | direction | direction |
| | PETG1 | PETG2 | PETG3 | APET | PBT | Additive | temperature | temperature | temperature | stretch ratio | stretch ratio |
| | (pbw) | (pbw) | (pbw) | (pbw) | (pbw) | (pbw) | (° C.) | (° C.) | (° C.) | (%) | (%) |
| Example 1 | 90 | | | 10 | | 0.8 | 80 | 80 | 78 | 100 | 500 |
| Example 2 | 70 | | | 30 | | 0.8 | 80 | 80 | 78 | 100 | 500 |
| Example 3 | 50 | | | 50 | | 0.8 | 80 | 80 | 78 | 100 | 500 |
| Example 4 | 30 | | | 70 | | 0.8 | 80 | 80 | 78 | 100 | 500 |
| Example 5 | | | 65 | 25 | 10 | 1 | 87 | 88 | 85 | 110 | 500 |
| Comparative | 100 | | | | | 0.8 | 90 | 83 | 81 | 100 | 500 |
| Example 1 | | | | | | | | | | | |
| Comparative | | 100 | | | | 0.8 | 90 | 83 | 81 | 100 | 500 |
| Example 2 | | | | | | | | | | | |

TABLE 2

| | Configuration | | | | | | | | | | | | | | | | | | |
|---|---|---|---|---|---|---|---|---|---|---|---|---|---|---|---|---|---|---|---|
| | (a) | | | | | | | | (i) | | | | | | | | | | |
| | E1 − | (b) | (c) | | (d) | (e) | (f) | (g) | Haze | | | | | | | | | | |
| | E2 | A1 | E1 | E2 | A2 | A3 | C | b* | value | Eva | Eva 2 | | | Eva | Eva | Eva | Eva | Eva | Eva |
| | (MPa) | (%) | (MPa) | (MPa) | (%) | (%) | (MPa) | (—) | (%) | 1 | 2-1 | 2-2 | 2-3 | 3 | 4 | 5 | 6 | 7 | 8 |
| Example 1 | 26.4 | 70 | 50.7 | 24.3 | 47 | 15 | 1481 | 0.17 | 4.1 | ⊙ | ⊙ | ⊙ | ⊙ | ⊙ | ⊙ | ⊙ | ⊙ | ◯ | ◯ |
| Example 2 | 26.7 | 51 | 53.4 | 26.7 | 35 | 3 | 1489 | 0.21 | 4.6 | ⊙ | ⊙ | ⊙ | ⊙ | ⊙ | ⊙ | ⊙ | ⊙ | ⊙ | ⊙ |
| Example 3 | 31.1 | 32 | 59 | 27.9 | 18 | 1 | 1586 | 0.25 | 5.3 | ⊙ | ⊙ | ⊙ | ⊙ | ◯ | ⊙ | ⊙ | ⊙ | ⊙ | ⊙ |
| Example 4 | 28.5 | 51 | 57.1 | 28.6 | 38 | 0 | 1605 | 0.40 | 4.5 | ⊙ | ⊙ | ⊙ | ⊙ | ⊙ | ⊙ | ⊙ | ⊙ | ⊙ | ⊙ |
| Example 5 | 23.6 | 75 | 56.4 | 32.8 | 46.5 | 3 | 1555 | 0.20 | 4.5 | ⊙ | ⊙ | ⊙ | ◯ | ⊙ | ⊙ | ⊙ | ⊙ | ⊙ | ⊙ |
| Compar- | 23.1 | 77 | 50.1 | 27 | 55 | 22 | 1302 | 0.12 | 3.3 | ⊙ | ⊙ | ⊙ | Δ | ◯ | X | Δ | X | X | Δ |
| ative | | | | | | | | | | | | | | | | | | | |
| Example 1 | | | | | | | | | | | | | | | | | | | |
| Compar- | 21.7 | 71 | 49.4 | 27.7 | 50 | 22 | 1321 | 0.10 | 3.6 | ⊙ | ⊙ | ⊙ | X | ⊙ | ◯ | Δ | X | X | Δ |
| ative | | | | | | | | | | | | | | | | | | | |
| Example 2 | | | | | | | | | | | | | | | | | | | |

*Eva 1: Variation in thickness
*Eva 2: Lower yield point stress
*Eva 3 to 5: Thermal shrinkage ratios A1 to A3
*Eva 6: Tensile modulus of elasticity
*Eva 7: Breakage prevention property
*Eva 8: Value of b* in chromaticity coordinates

### INDUSTRIAL APPLICABILITY

According to the present invention, with regard to a heat-shrinkable polyester film derived from a polyester resin composition including a crystalline polyester resin in an amount in a range of 10% to 70% by weight with respect to the total resin amount, by satisfying at least configurations (a) and (b), the heat-shrinkable polyester film has satisfactory thermal shrinkage ratios, and at the same time, after the heat-shrinkable polyester film is produced into a shrink label and is shrunk to be wrapped around a bottle, excellent breakage prevention property that does not cause damage of the label during transportation and storage can be obtained.

Particularly, even in a case where the thermal shrinkage conditions vary, or the shape of the PET bottle to which the heat-shrinkable polyester film is applied changes slightly, the heat-shrinkable polyester film is thermally shrunk stably in a wide temperature range (for example, at 70° C. to 100° C. for 10 seconds), and excellent breakage prevention property can be obtained.

Therefore, according to the heat-shrinkable polyester film of the present invention, since versatility can be remarkably enhanced by suitably applying the heat-shrinkable polyester film to various PET bottles, outer covering materials for lunch boxes and the like, it can be said that the industrial applicability of the heat-shrinkable polyester film is very high.

1. A heat-shrinkable polyester film derived from a polyester resin composition including a crystalline polyester resin in an amount in a range of 10% to 70% by weight with respect to a total resin amount,
wherein a main shrinkage direction is designated as TD direction, and a direction orthogonally intersecting the TD direction is designated as MD direction, and the heat-shrinkable polyester film satisfies the following configurations (a) and (b):
(a) when an upper yield point stress in a stress-strain curve in the MD direction is designated as E1 (MPa), and a lower yield point stress is designated as E2 (MPa), the value of E1−E2 satisfies the following relational expression (1):
$$23.5 \leq E 1 - E 2 \leq 50 ; \qquad ( 1 )$$
(b) when a thermal shrinkage ratio in a case where the heat-shrinkable polyester film is shrunk in the TD direction under the conditions of 10 seconds in hot water at 98° C. is designated as A1, the A1 has a value of 30% or more.

2. The heat-shrinkable polyester film according to claim 1, wherein as configuration (c), a value of the upper yield point stress E1 is larger than a value of the lower yield point stress E2, the E1 has a value within a range of 40 to 70 MPa, and the E2 has a value within a range of 15 to 45 MPa.

3. The heat-shrinkable polyester film according to claim 1, wherein as configuration (d), when a thermal shrinkage ratio in a case where the heat-shrinkable polyester film is shrunk in the TD direction under the conditions of 10 seconds in hot water at 80° C. is designated as A2, the A2 has a value of 51% or less.

4. The heat-shrinkable polyester film according to claim 1, wherein as configuration (e), when a thermal shrinkage ratio in a case where the heat-shrinkable polyester film is shrunk in the TD direction under the conditions of 10 seconds in hot water at 70° C. is designated as A3, the A3 has a value of 20% or less.

5. The heat-shrinkable polyester film according to claim 1, wherein as configuration (f), when a tensile modulus of elasticity in the MD direction as measured according to JIS K 7127:1999 is designated as C, the C has a value in a range of 1400 to 1800 MPa.

6. The heat-shrinkable polyester film according to claim 1, wherein as configuration (g), b* in chromaticity coordinates in a CIE1976 L*a*b* color space as measured according to JIS Z 8781-4:2013 has a value within a range of 0.15 to 0.5.

7. The heat-shrinkable polyester film according to claim 1, wherein as configuration (h), a thickness of the film before thermal shrinkage has a value within a range of 10 to 100 μm.

8. The heat-shrinkable polyester film according to claim 1, wherein as configuration (i), a haze value of the film before thermal shrinkage as measured according to JIS K 7136:2000 has a value of 8% or less.
